(19) United States
(12) Patent Application Publication
(10) Pub. No.: US 2013/0211979 A1
(43) Pub. Date: Aug. 15, 2013

(54) COMPUTER SYSTEM, COMPUTER SYSTEM IMPLEMENTED METHOD, AND COMPUTER PROGRAM PRODUCT FOR CLIENT TRUST ACCOUNTING PROCESSING

(71) Applicant: PELORUS TECHNOLOGY, LLC, (US)

(72) Inventor: Erik Cornet, Austin, TX (US)

(73) Assignee: PELORUS TECHNOLOGY, LLC, Austin, TX (US)

(21) Appl. No.: 13/764,471

(22) Filed: Feb. 11, 2013

Related U.S. Application Data
(60) Provisional application No. 61/597,606, filed on Feb. 10, 2012.

(51) Int. Cl. G06Q 40/00; G06Q 50/18

(52) U.S. Cl. CPC G06Q 40/10; G06Q 50/18
USPC 705/30

(57) ABSTRACT

A computer system including a microprocessor and a storage medium, wherein the storage medium stores an accounting program. The storage device is connected to the microprocessor. The accounting programs is read by the microprocessor and operated the instructions of the accounting program. The instructions in the accounting program implement a method that receives user inputs indicating a certain client matter and a received payment amount, creates at least one entry for an operating account, determines at least one outstanding balance for at least one invoice for the certain client matter, and automatically creates at least one entry for the operating account and one entry for an IOLTA trust account.

### CROSS REFERENCE TO RELATED APPLICATION

This application is entitled to the benefit of the filing date of U.S. Application No. 61/597,606.

### FIELD OF THE INVENTION

This invention relates generally to the field of computer systems and computer programs and more particularly to accounting systems and programs.

### BACKGROUND

Law firms, like other service organizations, have a duty to ensure that their client's funds are accurately applied to the right client and matter accounts. Sometimes, a law firm client will make an initial retainer payment or other funds held in trust. In those circumstances, the law firm is required to keep the funds in an special type of account referred to as an Interest On Lawyers Trust Accounts (hereinafter referred to as “IOLTA”). Overpayments and other clients funds are also stored in IOLTA accounts. Most law firms do not maintain a separate IOLTA trust bank account for each matter they handle, but rather have a single IOLTA trust bank account into which all client funds are deposited.

Many law firms use standard “off-the-shelf” accounting programs to track their payments, invoices, and other related financial aspects of their business. Unfortunately, current off-the-shelf accounting programs are not configured to handle the specific IOLTA related transaction that are imposed on law firms. There is, therefore, a need to for a system that can reliably track and manage IOLTA transactions for a law firm. It is to this and other deficiencies in the prior art that the present invention is directed.

### SUMMARY OF THE INVENTION

The following presents a simplified summary of embodiments of the invention in order to provide a basic understanding of some aspects thereof. It is intended neither to identify key elements of the invention nor to delineate its scope. This summary is not an extensive overview. Its sole purpose is to present some concepts of embodiments of the invention in a simplified form as a prelude to a more detailed description that is presented thereafter.

In embodiments of the invention, a computer system has a microprocessor and a storage device connected to the microprocessor, such that the storage device is readable by the microprocessor. The storage device has stored thereon an accounting program for controlling the processor to process a payment. The processor is operative with the accounting program to execute the program for receiving a user input indicating a certain client account, a user input indicating a received payment is to be applied to the certain client account, and a user input indicating an amount of the received payment. The processor is operative with the accounting program to execute the program for creating at least one entry for an operating account, determining at least one outstanding balance amount for at least one invoice for the certain client account and computing an overpayment difference between the amount of the received payment and the at least one outstanding balance amount. And the processor is operative with the accounting program to execute the program for automatically creating, responsive to determining the overpayment difference, at least one entry for the IOLTA account and at least one entry for a client trust account.

Embodiments of the invention include embodiments in the form of a computer system, a computer system implemented method and a computer program product. Novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings and illustrations.

### BRIEF DESCRIPTION OF THE DRAWINGS

FIG. 1 illustrates a logical depiction of a computer system.

FIG. 2 illustrates a method for processing an IOLTA payment.

FIG. 3 illustrates a method for processing an IOLTA disbursement.

FIG. 4 illustrates a method for processing an IOLTA transfer.

FIG. 5 illustrates a method for settling multiple invoices with a potential overpayment being processed into the IOLTA account.

### DETAILED DESCRIPTION OF THE PREFERRED EMBODIMENTS

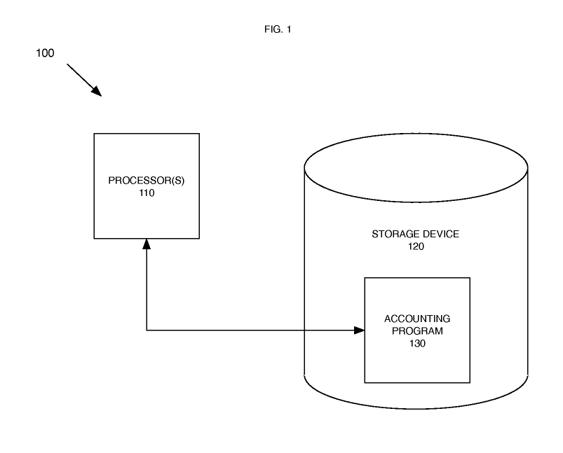

In accordance with a preferred embodiment of the present invention, FIG. 1 provides a general diagrammatic depiction of a computer system 100. The computer system 100 preferable includes at least one processor 110 and a storage device 120. The storage device 120 has stored thereon an accounting program 130. The processor 110 is operative with the accounting program 130 in that the processor 110 can perform various steps as instructed by the accounting program 130.

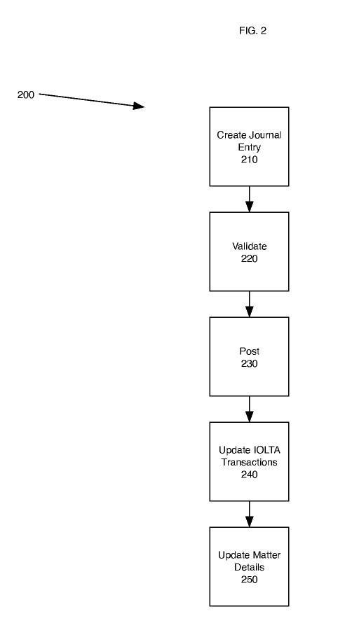

In the preferred embodiment, the accounting program 130 is a customized version of Microsoft Corporation's Dynamics AX. The preferred embodiment of the accounting program 130 includes several customized methods that enable the computer system 100 to manage certain types of transactions related to the management of IOLTA accounts by law firms. These customized methods are depicted in FIGS. 2, 3, 4, and 5. It will be understood by those skilled in the art that the accounting program 130 will keep track of certain accounts, including an IOLTA Trust Bank Account and an IOLTA Trust Liability Account. The identify of these accounts can be input by a user, and will be stored by the accounting program 130.

FIG. 2 depicts a method 200 for receiving funds and posting those funds into a law firm's IOLTA account. The method beings with step 210, wherein a user inputs certain parameters to create a journal entry in the accounting program 130. In the preferred embodiment, step 210 is initiated by using the accounting program 130 to launch a journal entry screen and then inputting a journal type of “IOLTA”, a date that the user desires the journal entry to post to a general ledger of the accounting program 130, transaction text that details what the journal entry concerns (e.g., “Retainer receipt from client . . . ”), an amount to credit to a particular client account/matter, a method of payment indicating how the funds were received (e.g., “Check,” “Wire,” “Cash,” or other applicable method), a funds identifier that identifies the particular method of payment (e.g., check number, wire transfer number, or other applicable identifier), a funds date that identifies the date of the particular method of payment (e.g, date of check, wire transfer, or other applicable date), a reason code, a group identifier that identifies the practice group for the client matter to which the funds apply, an employee identifier that identifies the employee who is responsible for the transaction, and a matter identifier that identifies the matter to which the funds should be applied. In the preferred embodiment, the group identifier, employee identifier and matter identifier are input in a difference screen from the other parameters. In alternative embodiments, the group identifier, employee identifier and matter identifier may be input on the same screen as the other parameters or on separate screens.

After the user has finished inputting the parameters in step 210, the journal entry is validated in step 220. In the preferred embodiment, this occurs when the user presses a “validate” button on the journal entry screen. Validation of the journal entry is performed by comparing the values of the certain parameters against a set of defined business rules. Those business rules ensure that all required parameters are populated before processing of method 200 is permitted to continue. In the preferred embodiment, the set of business rules require that the date, client account, transaction text, amount of the transaction, journal type, method of payment, document identifier and document date are all populated. If the journal entry passes each of the business rules in the set of business rules, then processing passes to step 230.

In step 230, the accounting program 130 presents and informs the user that the journal entry was validated, and gives the user an opportunity to post the journal entry. In the preferred embodiment, the user can elect to post the journal entry by pressing a “Post” button, or may end all processing of method 200 by closing the journal entry screen without pressing the “Post” button. If the user elects to post the journal entry, then processing passes to step 240.

In step 240, the accounts on the general ledger are updated. In particular, the IOLTA Trust Bank Account is updated by the amount input by the user in step 210, and the IOLTA Trust Liability Account is updated by the same amount. Processing then passes to step 250.

In step 250, a resulting balance is calculated for the matter identified by the matter identifier. The resulting balance reflects the amount of funds left in the IOLTA Trust Bank Account that are specifically tied to the matter identified by the matter identifier. This resulting balance can be displayed to the user. In the preferred embodiment, the resulting balance is displayed on a “Matter Details” screen that resulting balance along with all invoices associated with the matter identified by the matter identifier. In an alternative embodiment, the resulting balance of funds for the IOLTA Trust Bank Account is calculated for the employee identifier input in step 210 and is displayed to the user. In yet another alternative embodiment, the resulting balance for the group identifier input in step 210 is calculated and is displayed to the user.

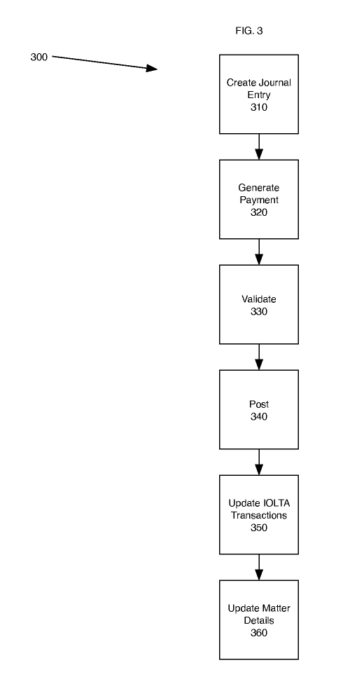

FIG. 3 depicts a method 300 for processing an IOLTA Disbursement. The method beings with step 310, wherein a user inputs certain parameters to create a journal entry in the accounting program 130. In the preferred embodiment, step 310 is initiated by using the accounting program 130 to launch a journal entry screen and then inputting a journal type of “IOLTA”, a date that the user desires the journal entry to post to a general ledger of the accounting program 130, transaction text that details what the journal entry concerns (e.g., “Retainer receipt from client . . . ”), an amount for the transaction from the IOLTA Trust Bank Account for a particular client account/matter, a method of payment indicating how the funds will be dispersed (e.g., “Check,” “Wire,” “Cash,” or other applicable method), a funds identifier that identifies the particular method of payment (e.g., check number, wire transfer number, or other applicable identifier), a funds date that identifies the date of the particular method of payment (e.g, date of check, wire transfer, or other applicable date), a reason code, a group identifier that identifies the practice group for the client matter to which the funds apply, an employee identifier that identifies the employee who is responsible for the transaction, and a matter identifier that identifies the matter to which the funds should be applied. In the preferred embodiment, the group identifier, employee identifier and matter identifier are input in a different screen from the other parameters.

After the user has finished inputting parameters in step 310, processing passes to step 320. In step 320, the user confirms that the method of payment parameter, the IOLTA Trust Bank Account and the funds identifier are correct and then generates the payment. In the preferred embodiment, this is done by displaying these parameters to the user in a modal dialog box and presenting the user with an “OK” button and a “Cancel” button. If the user presses the “OK” button, then the payment is generated (e.g., the check is printed by the accounting program 130). If the user presses “Cancel” (or otherwise closes the modal dialog box) then the processing of method 300 terminates. Once the payment is generated in step 320, processing passes to step 330.

In step 330, the journal entry created in step 310 is validated. In the preferred embodiment, this occurs when the user presses a “validate” button on the journal entry screen. Validation of the journal entry is performed by comparing the values of the certain parameters against a set of defined business rules. Those business rules ensure that all required parameters are populated before processing of method 300 is permitted to continue. In the preferred embodiment, the set of business rules require that the date, client account, transaction text, amount of transaction, journal type, method of payment, document identifier and document date are all populated. Preferably, the set of business rules also requires that the IOLTA Trust Bank Account have sufficient funds (i.e., greater than or equal to the amount to of the transaction) related to the matter identified by the matter identifier. If the journal entry passes each of the business rules in the set of business rules, then processing passes to step 340.

In step 340, the accounting program 130 presents the informs the user that the journal entry was validated, and gives the user an opportunity to post the journal entry. In the preferred embodiment, the user can elect to post the journal entry by pressing a “Post” button, or may end all processing of method 300 by closing the journal entry screen without pressing the “Post” button. If the user elects to post the journal entry, then processing passes to step 350.

In step 350, the accounts on the general ledger are updated. In particular, the IOLTA Trust Bank Account is updated by the amount of the transaction input by the user in step 310, and the IOLTA Trust Liability Account is updated by the same amount. Processing then passes to step 360.

In step 360, a resulting balance is calculated for the matter identified by the matter identifier. The resulting balance reflects the amount of funds left in the IOLTA Trust Bank Account that are specifically tied to the matter identified by the matter identifier. This resulting balance can be displayed to the user. In the preferred embodiment, the resulting balance is displayed on a “Matter Details” screen that resulting balance along with all invoices associated with the matter identified by the matter identifier. In an alternative embodiment, the resulting balance of funds for the IOLTA Trust Bank Account is calculated for the employee identifier input in step 310 and is displayed to the user. In yet another alternative embodiment, the resulting balance for the group identifier input in step 310 is calculated and is displayed to the user.

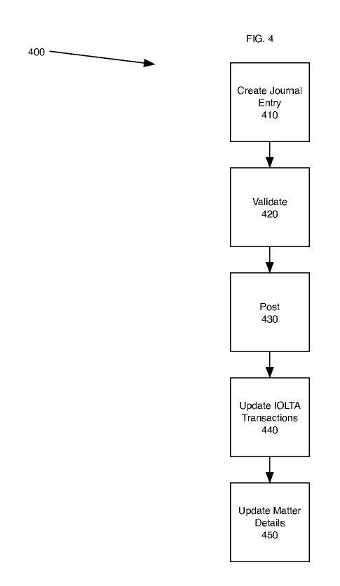

FIG. 4 depicts a method 400 for processing an IOLTA transfer from a first matter to a second matter. The method beings with step 410, wherein a user inputs certain parameters to create a journal entry in the accounting program 130. In the preferred embodiment, step 410 is initiated by using the accounting program 130 to launch a journal entry screen and then inputting a journal type of “IOLTA”, a date that the user desires the journal entry to post to a general ledger of the accounting program 130, transaction text that details what the journal entry concerns (e.g., “Retainer receipt from client . . . ”), an amount to update the IOLTA Trust Bank Account for the first matter, an amount to update the IOLTA Trust Bank Account for the second matter, a document identifier that identifies the document ordering the transfer from the first matter to the second matter, a document date that identifies the date of that document, a group identifier that identifies the practice group for the client matter to which the funds apply, an employee identifier that identifies the employee who is responsible for the transaction, and a matter identifier that identifies the matter to which the funds should be applied. In the preferred embodiment, the group identifier, employee identifier and matter identifier are input in a difference screen from the other parameters. In alternative embodiments, the group identifier, employee identifier and matter identifier may be input on the same screen as the other parameters or on separate screens.

After the user has finished inputting parameters in step 410, processing passes to step 420. In step 420, the journal entry created in step 410 is validated. In the preferred embodiment, this occurs when the user presses a “validate” button on the journal entry screen. Validation of the journal entry is performed by comparing the values of the certain parameters against a set of defined business rules. Those business rules ensure that all required parameters are populated before processing of method 300 is permitted to continue. In the preferred embodiment, the set of business rules require that the date, client account for the first matter, the client account for the second matter, transaction text, amount of the transaction, journal type, method of payment, document identifier and document date are all populated. Preferably, the set of business rules also requires that the IOLTA Trust Bank Account have sufficient funds (i.e., greater than or equal to the amount of the transaction) related to the matter identified by the matter identifier. If the journal entry passes each of the business rules in the set of business rules, then processing passes to step 430.

In step 430, the accounting program 130 presents the informs the user that the journal entry was validated, and gives the user an opportunity to post the journal entry. In the preferred embodiment, the user can elect to post the journal entry by pressing a “Post” button, or may end all processing of method 400 by closing the journal entry screen without pressing the “Post” button. If the user elects to post the journal entry, then processing passes to step 440.

In step 440, the accounts on the general ledger are updated. In particular, the IOLTA Trust Bank Account is updated by the amount input by the user in step 410 for the first matter, and the IOLTA Trust Liability Account is updated by the same amount. Then, the IOLTA Trust Bank Account is updated by the amount input by the user in step 410 for the second matter, and the IOLTA Trust Liability Account is updated by the same amount. Processing then passes to step 410.

In step 450, resulting balances are calculated for the first matter and the second matter. The resulting balances reflects the amount of funds left in the IOLTA Trust Bank Account for the first matter and second matter. This resulting balances can be displayed to the user. In the preferred embodiment, the resulting balance is displayed on a “Matter Details” screen that resulting balance along with all invoices associated with the first matter or the second matter. In an alternative embodiment, the resulting balance of funds for the IOLTA Trust Bank Account is calculated for the employee identifier input in step 410 and is displayed to the user. In yet another alternative embodiment, the resulting balance for the group identifier input in step 410 is calculated and is displayed to the user.

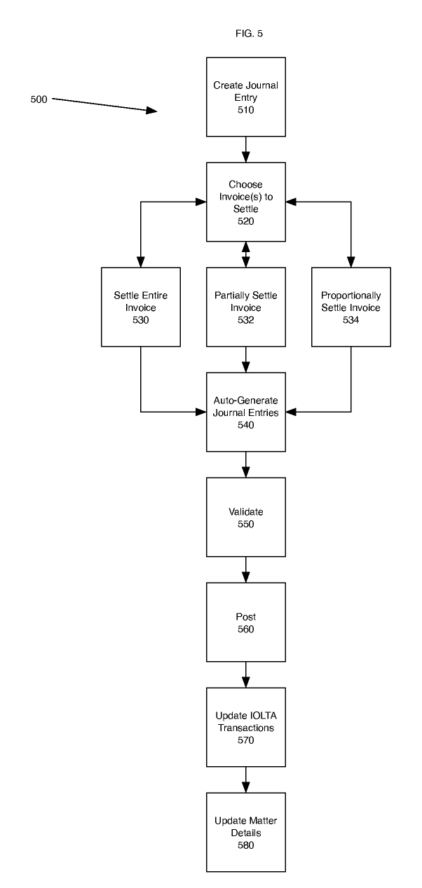

FIG. 5 depicts a method 500 for processing an IOLTA transfer from a first matter to a second matter. The method beings with step 510, wherein a user inputs certain parameters to create a journal entry in the accounting program 130. In the preferred embodiment, step 510 is initiated by using the accounting program 130 to launch a journal entry screen and then inputting a journal with the name “ARPay” and a description of “Client Payments—To Operating <Date>.” Naming the journal entry in this manner allowed for easier reference as a later date. The user then inputs a date that the user desires the journal entry to post to a general ledger of the accounting program 130, an account identifier that identifies the client account to which the payment should be applied, transaction text that details what the journal entry concerns (e.g., “Payment for march invoice . . . ”), an amount to apply against invoices associated with that client account, a method of payment indicating how the funds were paid (e.g., “Check,” “Wire,” “Cash,” or other applicable method), a funds identifier that identifies the particular method of payment (e.g., check number, wire transfer number, or other applicable identifier), and a funds date that identifies the date of the particular method of payment (e.g, date of check, wire transfer, or other applicable date).

After the user finishes inputting parameters in step 510, processing passes to step 520. In step 520, the user selects which invoices to settle. In the preferred embodiment, this is accomplished by presenting the user with a “Settlement” screen that presents the user with a list of all invoices that: (a) are associated with the client account identified in step 510; and (b) have an unsettled balance. The user then may select the invoice to. Once the user has selected which invoice to settle, the user is presented with a screen showing all of the line items on the selected invoice and is asked to choose the method of settlement. In the preferred embodiment, there are three different methods of settlement: Settle Entire Invoice, Partially Settle Invoice, and Proportionally Settle Invoice.

If the user selects the Settle Entire Invoice method of settlement, processing passes to step 530. In step 530, the full amount input in step 510 is applied against the selected invoice, and processing is passed to step 540. If the user selects the Partially Settle Invoice method of settlement, processing passes to step 532 and the user then inputs a settle amount for each line item on the selected invoice, and processing is passed to step 540. If the user selected the Proportionally Settle Invoice method of settlement, then processing is passed to step 534 wherein the expense line items of the selected invoice will be settled first, and then the remaining line items will be settled proportionally by dividing the difference of the amount of the transaction and the total of the expense items across the remaining line items of the selected invoice, and processing is passed to step 540. It will be understood by those skilled in the art that if the full amount of the transaction is greater than the unsettled amount of the selected invoice, processing can repeatedly be returned to step 520 so that the user can continue to select invoices to settle until the total of the unsettled amounts of the selected invoices is equal to or greater than the amount input by the user in step 510.

In step 540, the accounting program 130 automatically generates additional journal entries for the general ledger for each invoice selected in step 520. If the total unsettled amount of the selected invoices is less than the full amount entered, then the accounting program 130 will also create journal entries showing the movement of the excess funds into the IOLTA Trust Bank Account and the related client matter. In the preferred embodiment, the user is then required to input a group identifier that identifies the practice group for the client matter associated with each journal entry, an employee identifier that identifies the employee who is responsible for each journal entry, and a matter identifier that identifies the matter to associated with each journal entry. Processing is then passed to step 550.

In step 550, the journal entries created in step 510 and 540 are validated. In the preferred embodiment, this occurs when the user presses a “validate” button on the journal entry screen. Validation of the journal entries is performed by comparing the values of the certain parameters against a set of defined business rules. Those business rules ensure that all required parameters are populated before processing of method 500 is permitted to continue. If the journal entry passes each of the business rules in the set of business rules, then processing passes to step 560.

In step 560, the accounting program 130 presents the informs the user that the journal entry was validated, and gives the user an opportunity to post the journal entries. In the preferred embodiment, the user can elect to post the journal entries by pressing a “Post” button, or may end all processing of method 500 by closing the journal entry screen without pressing the “Post” button. If the user elects to post the journal entry, then processing passes to step 570.

In step 570, the accounts on the general ledger are updated. In particular, the cash account is updated for the amount of the payment, the A/R account is updated for the amount of the payment, the uncollected accounts are updated for the amount for the payment in the amounts associated with each selected invoice, and the collected accounts are updated for the amount of the payment in the amounts associated with the selected invoices. In the event that an overpayment was made (i.e., the full amount parameter>the total unsettled amounts from the selected invoices) then the IOLTA Trust Bank Account is updated by the difference of the full amount parameter input in step 510 and the total of the unsettled amounts from the invoices selected in step 520. Processing is then passed to step 580.

In step 580, a resulting balance is calculated for each of the matters identified in step 540. The resulting balances reflects the amount of funds left in the IOLTA Trust Bank Account that are specifically tied to each matter identified by the matter identifier input in step 540. This resulting balances can be displayed to the user. In the preferred embodiment, the resulting balances are displayed on a “Matter Details” screen that displays the resulting balance along with all invoices associated with the matter identified by the matter identifier. In an alternative embodiment, the resulting balance of funds for the IOLTA Trust Bank Account is calculated for the employee identifier input in step 510 and is displayed to the user. In yet another alternative embodiment, the resulting balance for the group identifier input in step 510 is calculated and is displayed to the user.

As will be appreciated by one skilled in the art, aspects of the present invention may be embodied as a system, method or program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including Microsoft Dynamics AX. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and program products according to embodiments of the invention. It will be understood that each block of the flowchart illustrations and/or block diagrams, and combinations of blocks in the flowchart illustrations and/or block diagrams, can be implemented by program instructions. These program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more databases may be included in a host for storing and providing access to data for the various implementations. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption and the like.

The database may be any type of database, such as relational, hierarchical, object-oriented, and/or the like. Common database products that may be used to implement the databases include Microsoft SQL Server. The database may be organized in any suitable manner, including as data tables or lookup tables.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

The flowcharts and block diagrams in the figures illustrate the architecture, functionality, and operation of possible implementations of systems, methods and program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules implemented in software for execution by various types of processors may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the descriptions herein, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Benefits, advantages and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims.

Those skilled in the art having read this disclosure will recognize that changes and modifications may be made to the embodiments without departing from the • scope of the present invention.

It should be appreciated that the particular implementations shown and described herein are illustrative of the invention and its best mode and are not intended to otherwise limit the scope of the present invention in any way. Other variations are within the scope of the following claims.

While this specification contains many specifics, these should not be construed as limitations on the scope of the invention or of what can be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as essential or critical.

What is claimed is:

1. A computer system having a microprocessor and a storage device connected to the microprocessor, wherein the storage device has stored thereon an accounting program readable by the microprocessor for controlling the processor to process a payment, and wherein the processor is operative with the accounting program to execute instructions for performing:
receiving, by the microprocessor, a user input indicating a certain client account;
receiving, by the microprocessor, a user input indicating a received payment is to be applied to the certain client account;
receiving, by the microprocessor, a user input indicating an amount of the received payment;
creating, by the microprocessor responsive to the received payment amount, at least one first entry for an operating account;
determining, by the microprocessor, at least one outstanding balance amount for at least one invoice for the certain client account and computing an overpayment difference between the amount of the received payment and the at least one outstanding balance amount; and
automatically creating, by the microprocessor responsive to determining the overpayment difference, at least one second entry for the operating account and at least one entry for a client trust account.

2. The system of claim 1 wherein the first entry for an operating account is a credit.

3. The system of claim 1 wherein the second entry for the operating account is a debit.

4. The system of claim 1 wherein the processor is additionally operative with the accounting program to execute instructions for displaying, by the microprocessor, the overpayment difference.

5. The system of claim 1 wherein the processor is additionally operative with the accounting program to execute instructions for receiving, by the microprocessor, at least one parameter.

6. The system of claim 5, wherein one of the parameters is a group identifier.

7. The system of claim 6, wherein one of the parameters is an employee identifier.

8. The system of claim 5, wherein one of the parameters is matter identifier.

9. A method in a computer system having a microprocessor and a storage device connected to the microprocessor, wherein the storage device has stored thereon an accounting program readable by the microprocessor for controlling the processor, which comprises the steps of:
receiving, by the microprocessor, a plurality of user inputs that indicate a certain client matter, a date to post a transaction, and a payment amount;
posting, by the microprocessor, a plurality of journal entries in a general ledger that show a balance of funds in an IOLTA trust account for the certain client matter;

10. The method of claim 9 wherein the method further comprises the step of validating, by the microprocessor, the plurality of user inputs against a set of business rules.

11. The method of claim 10 wherein one of the user inputs is a group identifier.

12. The method of claim 11, wherein one of the user inputs is an employee identifier.

13. The method of claim 12, wherein one of the user inputs is a matter identifier.

14. The method of claim 13 further comprising the step of displaying, by the microprocessor, the balance of funds in the IOLTA trust account for the group identifier.

15. The method of claim 13 further comprising the step of displaying, by the microprocessor, the balance of funds in the IOLTA trust account for the employee identifier.

16. The method of claim 13 further comprising the step of displaying, by the microprocessor, the balance of funds in the IOLTA trust account for the matter identifier.

17. A method in a computer system having a microprocessor and a storage device connected to the microprocessor, wherein the storage device has stored thereon an accounting program readable by the microprocessor for managing IOLTA transactions for a law firm, which comprises the steps:
accepting a client payment;
processing the client payment into an IOLTA trust bank account;
disbursing funds from the IOLTA trust bank account; and
transferring funds in the IOLTA trust bank account from a first client matter to a second client matter.

18. The method of claim 17 further comprising the steps of:
partially settling a plurality of user-selected invoice line items;
calculating the presence of an overpayment; and
depositing any overpayment into the IOLTA trust bank account.

19. The method of claim 17 further comprising the step of proportionally settling a plurality of user-selected invoice line items.

20. The method of claim 19 comprising the additional steps of
calculating the presence of an overpayment; and
depositing any overpayment into the IOLTA trust bank account.
